(19) United States
(12) Patent Application Publication
(10) Pub. No.: US 2014/0270235 A1
(43) Pub. Date: Sep. 18, 2014

(54) UNIVERSAL IN-WALL MULTI-ROOM WIRELESS AUDIO AND MULTI-ROOM WIRELESS COMMUNICATION SYSTEM

(71) Applicant: LEVITON MANUFACTURING CO., INC., Melville, NY (US)

(72) Inventors: Yuna Shin, Bothell, WA (US); Randall Todd Palmer, Duvall, WA (US); Dean Stanley Lipke, Mill Creek, WA (US); Frank Chin Hwan Kim, Woodinville, WA (US); Brian Alan Groenig, Lake Stevens, WA (US)

(73) Assignee: Leviton Manufacturing Co., Inc., Melville, NY (US)

(21) Appl. No.: 13/799,256

(22) Filed: Mar. 13, 2013

(51) Int. Cl. H04R 3/00

(52) U.S. Cl. CPC H04R 3/00
USPC 381/77

(57) ABSTRACT

Systems and methods for providing a universal distributed audio system including an integrated wireless repeater. In some embodiments, the system comprises an intelligent speaker system capable of receiving wireless audio signals (e.g., Bluetooth®, AirPlay®, etc.), decoding the audio signals, and playing the resulting audio in a room of a venue. Control of the intelligent speaker system may be provided via an application executing on a wireless consumer device. The intelligent audio system includes integrated wireless communication capabilities that allow the intelligent speaker system to perform as a wireless access point or wireless repeater to extend the coverage area of a wireless communications network. The intelligent speaker system includes a power supply and interface that allow for direct connection to a venue's electrical system.

### BACKGROUND OF THE INVENTION

1. Field of the Invention

The present invention is directed generally to systems and methods for providing wireless systems, and more specifically, to intelligent speaker systems including wireless audio and wireless communication features.

2. Description of the Related Art

In the past several years, wireless communication has become increasingly popular. Wireless communication encompasses various types of fixed, mobile, and portable applications, including two-way radios, cellular telephones, and wireless networking. Other examples of applications of radio wireless technology include global positioning system (GPS) units, garage door openers, wireless computer mice, keyboards and headsets, headphones, speakers, and radio receivers.

One popular wireless communication technology is Bluetooth®, a technology standard for exchanging data over short distances (using short-wavelength radio transmissions in the ISM band from 2400-2480 MHz) from fixed and mobile devices, creating personal area networks (PANs). Bluetooth® is often used to transmit audio signals from a transmitting device (e.g., a mobile phone, laptop, etc.) to a receiving device (e.g., headset, speakers, etc.).

### BRIEF DESCRIPTION OF THE SEVERAL VIEWS OF THE DRAWINGS

FIG. 1 is a schematic illustration of multiple rooms and coverage zones for fixed wireless audio devices present therein.

FIG. 2 is a functional block diagram of a fixed wireless audio device according to an embodiment of the present invention.

FIG. 3 is a functional block diagram of a wireless consumer device according to an embodiment of the present invention.

FIG. 4 is an illustration of a display screen of the wireless consumer device of FIG. 3.

FIG. 5 is a schematic illustration of the wireless repeater functionality of the fixed wireless audio device of FIG. 2.

FIG. 6 is a schematic illustration of another embodiment of a wireless audio communication system.

### DETAILED DESCRIPTION OF THE INVENTION

Embodiments of the present invention are directed to systems and methods for providing a universal distributed audio system including an integrated wireless repeater. In some embodiments, the system comprises an intelligent speaker system capable of receiving wireless audio signals (e.g., Bluetooth®, AirPlay®, etc.) from a wireless consumer device, decoding the received audio signals, and playing the resulting audio in a room of a venue. Control of the intelligent speaker system may be provided via an application executing on a wireless consumer device, such as a smart phone, laptop, tablet computer, desktop computer, television, etc. In other embodiments, control may be provided by a custom control device, such as a remote control module. In some embodiments, the application executing on the mobile computing devices may allow for source selection allowing the intelligent speaker system to toggle through two or more various wireless audio sources streaming audio signals to the intelligent speaker system. As discussed in further detail below, various embodiments of the intelligent speaker system include integrated wireless communication capabilities that allow the intelligent speaker system to perform as a wireless access point or wireless repeater to extend the coverage area of a wireless communications network (e.g., throughout a home or office building).

As will also be described in detail below, the intelligent speaker systems, or more generally, fixed wireless audio devices, communicate wirelessly with the wireless consumer devices. Many known wireless consumer devices are offered by different service providers. The devices operate in accordance with different known communication standards, such as CDMA, GSM, 3G, 4G, WiMAX, or the like. Operation of these various wireless devices is well known in the art, and need not be described in greater detail herein. These conventional devices operate at assigned frequencies. For example, some cell phones operate in the 800 MHz band while PCS devices operate in the 1.9 GHz band. Some devices are multimode and can operate in an analog or digital mode, and are capable of operating in different frequency bands. In addition, the wireless consumer devices may contain short-range transceivers (as compared to cellular transceivers), such as Bluetooth® or Wi-Fi® (IEEE 802.11). As will be discussed in greater detail below, short-range communication devices may be used within a venue (e.g. a home or office) to transmit audio signals to and provide control of the fixed wireless audio devices of the present invention.

FIG. 1 is a simplified schematic diagram illustrating the operation of a system 100 implementing the techniques described herein. FIG. 1 illustrates four rooms 1-4 of a venue 102, such as a home. FIG. 1 illustrates rooms 1 and 2 on a first level of the venue 102 and rooms 3 and 4 on a second level of the venue. Those skilled in the art will appreciate that this illustration is for convenience only. Thus, the system 100 is not limited to the arrangement illustrated.

As illustrated in FIG. 1, each of the rooms 1-4 includes one or more associated fixed wireless audio devices 104A-104F fixedly positioned therein. Specifically, room 1 includes fixed wireless audio devices 104A-104C, room 2 includes fixed wireless audio device 104D, room 3 includes fixed wireless audio device 104E, and room 4 includes fixed wireless audio device 104F. The fixed wireless audio devices 104A-104F may be generally referenced herein as the fixed wireless audio devices 104.

Each of the fixed wireless audio devices 104A-104F is configured to have short-range communication capabilities. The term “fixed wireless audio device,” as used herein, refers to the fact that the device is stationary during operation rather than any reference to its size or relative portability, however, the device may typically be housed in a small portable package or housing. The fixed wireless audio devices 104A-104F may be integrated into a single package that may be fixedly mounted in or on a wall, floor, or ceiling of the venue 102.

Also shown in FIG. 1 is a plurality of wireless consumer devices 106A-106E, which may generally be referenced herein as wireless consumer devices 106. As will be discussed in further detail below, as the wireless consumer devices 106 move into a room within a coverage area of one or more of the fixed wireless audio devices 104, the wireless consumer devices will begin to communicate with the fixed wireless audio devices. The various elements of the system 100 may now be described in greater detail with reference to FIGS. 2 and 3.

FIG. 2 is a functional block diagram of the fixed wireless audio device 104A shown in FIG. 1. Those skilled in the art will appreciate that in some embodiments the fixed wireless audio devices 104A-104F are essentially identical. The fixed wireless audio device 104A comprises a central processing unit (CPU) 110 and a memory 112. In general, the CPU 110 receives instructions and data from the memory 112 and executes those instructions. The CPU 110 may be implemented as a conventional microprocessor, microcontroller, programmable gate array, discrete circuit, application-specific integrated circuit (ASIC), or the like. The fixed wireless audio device 104A is not limited by any specific implementation of the CPU 110. Similarly, the memory 112 may be implemented by a variety of known technologies. The memory 112 may include dynamic memory, static memory, programmable memory, or the like. A portion of the memory 112 may be integrated into a single chip with the CPU 110. The fixed wireless audio device 104A is not limited by any specific implementation of the memory 112.

The block diagram of FIG. 2 also illustrates a transmitter 114. As will be described in greater detail below, the transmitter 114 is operative to transmit data to the wireless consumer devices 106 or other wireless devices (e.g., a wireless access point 116 shown in FIG. 1) that come within its coverage zone. For example, the transmitter 114 may be operative to transmit control signals to the other fixed wireless audio devices 104B-104F. FIG. 2 also illustrates a receiver 118. The receiver 118 is configured to receive data transmitted by one or more of the wireless consumer devices 106 or other devices. As discussed below, the receiver 118 is operative to receive audio signals from one or more wireless consumer devices 106, and to receive wireless data signals from wireless access points, such as the wireless access point 116 of FIG. 1. Those skilled in the art will appreciate that the transmitter 114 and receiver 118 may have common circuitry and be implemented as a transceiver 120. As used herein, the term “transceiver” a device that comprises one or more transmitters and one or more receivers which are combined and share common circuitry, as well as one or more transmitters and one or more receivers that do not have circuitry in common (e.g., a receiver/transmitter pair may be referred to as a transceiver). The transmitter 114 and receiver 118 are coupled to an antenna 122. The antenna 122 may be implemented using a variety of known designs, such as omnidirectional antennas, directional antennas, phased array antennas, and the like.

The fixed wireless audio device 104A further includes a speaker 124 coupled to an amplifier 126 configured to drive the speaker. The speaker 124 is configured to output sound, such as music, voice, or the like. In some embodiments, the fixed wireless audio device 104A also includes a visual output 128, such as one or more light emitting diodes (LED), a display, or the like. As discussed below, the visual output 128 may be used to provide visual signals to users within the same room as the fixed wireless audio device 104A.

The fixed wireless audio device 104A further includes a regulated power supply or converter 130 configured to receive power directly from an AC power source 132 of the venue 102. In some embodiments, the power supply 130 may be in the form of a switched-mode power supply (SMPS), but other types of power supplies may be used. For example, as shown in FIG. 1, the fixed wireless audio device 104A is coupled directly to the venue's electrical system via an electrical cable 134A (e.g., Romex®) that extends between the power supply 130 of the fixed wireless audio device and a junction box 136A of the electrical system, or an electrical cord to an electrical outlet. Specifically, the power supply 130 is configured to receive AC power (e.g., 110 V) and convert it into regulated DC power having one or more DC voltages suitable for operating the various components of the fixed wireless audio device 104A. Thus, during installation, an installer may simply mount the fixed wireless audio device 104A in or on a wall, floor, or ceiling of the venue 102 and tie in to the venue's existing electrical system to provide a power source for the fixed wireless audio device. In some embodiments, the power supply 130 may be additionally or alternatively configured to receive power from other common power sources, such as power over Ethernet (POE). As another example, in some embodiments the fixed wireless audio device 104A may include an on-board battery configured to provide a power source for the components of the fixed wireless audio device. The battery may comprise one or more replaceable and/or rechargeable batteries known in the art.

The fixed wireless audio device 104A also includes a wireless repeater control module 140 which allows the fixed wireless audio device to operate as a wireless repeater, also referred to as a wireless range extender. In general, the wireless repeater control module 140 is operative to receive an existing signal from a wireless router or access point of a primary network and to rebroadcast it to essentially create a second network. Those outside of the primary network but within the range of the fixed wireless audio device 104A will be able to connect through the new “repeated” second network. As can be appreciated, this wireless repeater functionality may be used to improve signal range and strength within the venue 102.

The various components illustrated in FIG. 2 are coupled together by a bus system 142. The bus system 142 may include a power bus, address bus, control bus, data bus, and the like. For the sake of convenience, these various busses are illustrated in FIG. 2 as the bus system 142.

FIG. 3 is an example functional block diagram of the wireless consumer device 106A shown in FIG. 1. Those skilled in the art will appreciate that the other wireless consumer devices 106B-106E contain similar circuitry and operate in a functionally similar manner.

As illustrated in FIG. 3, the wireless consumer device 106A contains many components similar to those described above with respect to the fixed wireless audio device 104A. Specifically, the wireless consumer device 106A includes a CPU 150 and a memory 152. In general, the CPU 150 obtains data and instructions from the memory 152 and executes those instructions. The CPU 150 may be implemented by a number of devices, such as those described above with respect to the CPU 110 shown in FIG. 2. Similarly, the memory 152 may be implemented in a variety of known technologies, such as those described above with respect to the memory 112 shown in FIG. 2.

The wireless consumer device 106A also includes a transmitter 154 and a receiver 156. As known in the art, the receiver 156 of the wireless consumer device 106A searches for a base station with which to communicate. Communication with a base station allows the wireless consumer device 106A to access one or more data networks (e.g., the Internet). In some implementations, the transmitter 154 and the receiver 156 share common circuitry and may be implemented as a transceiver 158. The transmitter 154 and receiver 156 are coupled to an antenna 160. Commonly, the antenna 160 of the wireless consumer device 106A is implemented as an omnidirectional antenna to provide the greatest possibility of detecting a suitable base station with which to communicate.

The wireless communication device 106A also includes one or more input devices 162 (e.g., a keypad, touch screen, microphone, and the like), audio output 164 (e.g., a speaker), and a display output 166 (e.g., an LCD display). As discussed below, the input device 162 and display output 166 may be used as a user interface by a user of the system 100 to control the operation thereof.

The wireless consumer device 106A also includes one or more short-range transceivers 168 coupled to an antenna 170. The short-range transceivers 168 may also be implemented as one or more separate transmitters and receivers. The wireless consumer device 106A may include, by way of example, a Bluetooth® transceiver and/or a Wi-Fi® transceiver (IEEE 802.11). Other conventional short-range transceivers may also be used. The short-range transceiver 168 in FIG. 3 is representative of one or more such short-range transceivers. In such an implementation, the fixed wireless audio device 104A may be a corresponding Bluetooth® device and Wi-Fi® device capable of communicating with the Bluetooth® and/or Wi-Fi® implementation of the short-range transceiver 168. In this regard, the fixed wireless audio device 104A may be implemented as a Wi-Fi® hotspot that may serve as a network access point for the wireless consumer device 106A.

The various components illustrated in FIG. 3 are coupled together by a bus system 172. The bus system 172 may include a power bus, address bus, control bus, data bus, and the like. For sake of convenience, these various busses are illustrated in FIG. 3 as the bus system 172.

Referring back to FIG. 1, the operation of the system 100 is now described. As shown, each of the fixed wireless audio devices 104A-104F is mounted in or on a wall, floor, or ceiling of one of the rooms 1-4 of the venue 102. The fixed wireless audio devices 104A-104F are coupled via respective electrical cables 134A-134F to respective junction boxes 136A-136F of the venue 102 to receive power from the electrical system thereof.

When the wireless consumer device 106A comes within the range of the fixed wireless audio device 104A, the wireless consumer device detects the fixed wireless audio device and registers or associates therewith. This process may be referred to as “pairing.” In some protocols such as Bluetooth®, two devices need only be paired together manually once, and then the two devices can connect automatically thereafter. Once the wireless consumer device 106A is connected to the fixed wireless audio device 104A, the wireless consumer device may stream audio signals to the fixed wireless audio device for decoding and real-time playback through the speaker 124 (see FIG. 2) of the fixed wireless audio device. The wireless consumer device 106A may stream audio signals to the fixed wireless audio device 104A using one or more wireless communication protocols. For example, in some embodiments the fixed wireless audio device 104A is configured to receive Bluetooth® and AirPlay® audio signals transmitted from a wireless consumer device 106. AirPlay® is a proprietary protocol developed by Apple, Inc. of Cupertino, Calif. that allows for wireless streaming audio, video, or other media.

As a user 180A moves throughout the venue 102 with the wireless consumer device 106A, the wireless consumer device may move out of range of the fixed wireless audio device 104A and within the range of the fixed wireless audio device 104E located in room 3. As this occurs, the fixed wireless audio device 104E may pair with the wireless consumer device 106A so that the wireless consumer device initiates streaming of audible signals to the fixed wireless audio device 104E such that user's 180B audio may continue to play. In this example, each of the wireless consumer devices 106A-106E may stream audio signals to a nearby fixed wireless audio device 104, such that different users (e.g., user 180A and user 180B) throughout the venue 102 may utilize different fixed wireless audio devices 104A-104F simultaneously. For example, the user 180A of the wireless consumer device 106A in room 1 may utilize fixed wireless audio device 104A in room 1, while the wireless consumer device 106D in room 3 may utilize the fixed wireless audio device 104E located in room 3.

In some embodiments, the fixed wireless audio devices 104A-104F are operative to communicate data, control, and/or audio signals with each other. This may be accomplished through wired and/or wireless communication. For example, the fixed wireless audio devices 104A, 104B, and 104D-104F may communicate wirelessly with each other, whereas the fixed wireless audio device 104C may be configured to communicate with the fixed wireless audio device 104A via a wired connection 184. In this example, the user 180B of the wireless consumer device 106B in room 1 may stream audio signals to the fixed wireless audio device 104A also in room 1, which may then rebroadcast the audio signals to one or more other fixed wireless audio devices 104B-104F within the venue 102 using a combination of wireless communication (with devices 104B and 104D-104F) and wired communication (with device 104C). Thus, using a single wireless consumer device 1068, sound may be played throughout the venue 102.

FIG. 4 illustrates a display 190 of the wireless consumer device 106A when executing a mobile application 192 (see FIG. 3) of the system 100. The mobile application 192 provides functionality to allow the user to control the operation of the system 100. As shown in FIG. 4, the mobile application 192 includes a source selection module 194, a zone selection module 196, a visual control module 198, and an intercom module 200. Each of these modules is discussed below.

The source selection module 194 is provided to allow the user to select which wireless consumer device 106A-106E is to be paired with a particular fixed wireless audio device 104A-104F at a given time. In some embodiments, the selection may be done manually. For example, the user may select a wireless consumer device 106 from a list of available wireless consumer devices. In some embodiments, the source selection module 194 may allow the user to configure a prioritization scheme for prioritized connection between the wireless consumer devices 106 and fixed wireless audio devices 104. For example, a parent may want his or her wireless consumer device 106 to have a higher priority for connection than a child's wireless consumer device.

In some embodiments, the source selection module 194 of the mobile application 192 is configured to automatically perform source selection based on one or more criteria. For example, the source selection module 194 may automatically select from a plurality of available wireless consumer devices 106A-106E based on the wireless consumer device that was most recently connected to the system 100. As another example, the source selection module 194 may automatically select from a plurality of available wireless consumer devices 106 based on the wireless consumer device that historically connects to the system 100 the most often, for the longest duration, etc. Those skilled in the art will recognize other criteria or combinations of criteria may be used by the source selection module 194 to automatically select an audio source.

The zone selection module 196 is configured to allow the user to select which zones of the venue 102 are to be active. For example, the user of the wireless consumer device 106A in room 1 may direct the zone selection module 196 to provide audio playback on all fixed wireless audio devices positioned in room 1 and room 2 only (i.e., devices 104A-104D). Another user of the wireless consumer device 106D located in room 3 may utilize the zone selection module 196 to instruct the system 100 to provide audio playback only on the fixed wireless audio device 104E located in room 3.

The zone selection module 196 may also allow users to configure schedules for the system 100. For example, if room 4 is a room in which a child sleeps, the user may utilize the zone selection module 196 to specify a rule that disables the fixed wireless audio device 104F in room 4 between the hours of 8 PM and 8 AM. As will be appreciated by those of skill in the art, the zone selection module 196 may be used to set other schedules as may be desired by users of the system 100.

The visual control module 198 may be used to control the visual output 128 (see FIG. 2) of the various fixed wireless audio devices 104A-104F of the system 100. For example, in the case where the visual output 128 comprises a plurality of differently colored LED lights, the visual control module 198 may be used to select which color or pattern of colors are displayed on respective fixed wireless audio devices 104. This feature may be used to set “mood lighting,” etc. In embodiments where the visual output 128 comprises a display, the visual control module 198 may be used to control the output of the display. In some embodiments, the visual output 128 may be utilized to provide notices or alerts to users. For example, the fixed wireless audio devices 104 may be configured to receive signals wirelessly from a doorbell or alarm system, and to activate the visual output 128 and/or the speaker 124 in response to activation of the doorbell or alarm system. In some embodiments, the user is able to select a particular audio file to play for the doorbell, such as a song, ringtone, etc. The visual control module 198 allows the user to configure the settings for these various functional operations.

In some embodiments, the mobile application 192 includes an intercom module 200. The intercom module 200 is configured to receive audio signals from an audio input device 162 (e.g., a microphone) (see FIG. 2) of the wireless consumer device 106A (or other wireless consumer device) and to transmit the audio signals (e.g., via Bluetooth®, AirPlay®, Wi-Fi®, or the like) to a fixed wireless audio device 104 of the system 100 located nearby. The audio signals may then be played back on a selected one or more fixed wireless audio devices 104 of the system. For example, the user may select “all zone page,” “one zone page,” etc. Thus, users may use their wireless consumer device 106 to act as an intercom to communicate with other people located in other rooms of the venue 102, or near the venue, such as at a home entrance, etc.

In some embodiments, the mobile application 192 executing on a wireless consumer device 106 may communicate directly with one or more of the fixed wireless audio devices 104 using a suitable wireless protocol, such as Bluetooth® or Wi-Fi®. In other embodiments, the wireless consumer device 106 may communicate with a remote server 210 (see FIG. 1) of the system 100 via the wireless access point 116 that is coupled to the remote server 210 over a network 212 (e.g., the Internet) (see FIG. 1). The remote server 210 may include control logic 214 for interfacing with the wireless consumer devices 106 and the fixed wireless audio devices 104. In this embodiment, one or more of the fixed wireless audio devices 104 are also operative to communicate with the remote server 210 via the wireless access point 116 and the network 212. It should be appreciated that the control functions or logic of the system 100 may be physically stored on one or more of the wireless consumer devices 106, the remote server 210, one or more of the fixed wireless audio devices 106, or any combinations thereof.

FIG. 5 is a schematic diagram illustrating the wireless repeater or extender functionality of the fixed wireless audio device 106. In this example, a venue 220 is shown that includes two zones, namely zone 1 and zone 2. A wireless access point 222 is located in zone 1. The wireless access point 222 may comprise a wireless router and a modem operatively coupled to the Internet 224. Wireless consumer devices 226A and 226B are located in zone 1 and are able to access the Internet 224 directly via the wireless access point 222.

Wireless consumer devices 228A-228C located in zone 2 are positioned out of the coverage area of the wireless access point 222 located in zone 1. In this example, a fixed wireless audio device 104G is mounted on a wall of zone 2. As described above, power is provided to the fixed wireless audio device 104G via an electrical cable 134G (e.g., Romex® cable) coupled to a junction box 136G of the electrical system of the venue 220. The wireless repeater control module 140 (see FIG. 2) of the fixed wireless audio device 104G is operative to receive signals from the wireless access point 222 located in zone 1 and to retransmit the signals into zone 2 to essentially create a second network in zone 2. Thus, the wireless consumer devices 228A-228C in zone 2 outside of the range of the wireless access point 222 in zone 1 are able to connect to the Internet 224 through the fixed wireless audio device 104G and the wireless access point 222. In larger venues, multiple fixed wireless audio devices 104 may operate as intermediate wireless repeaters between the wireless access point 222 and wireless consumer devices 228A-228C. As can be appreciated, the wireless repeater functionality may be used to improve signal range and strength of a wireless network within the venue 220.

FIG. 6 illustrates another embodiment of an intelligent wireless access point and universal distributed audio system 230. In this embodiment, a volume control unit 232 is provided that is mountable in or on a wall of a room 1 of a venue 234 (e.g., a home). In some embodiments, the volume control unit 232 may have the same or similar form factor as a light switch plate or panel. The volume control unit 232 comprises many of the components of the fixed wireless audio devices 104 discussed above and shown in FIG. 2. Specifically, the volume control unit 232 may comprise the CPU 110, the memory 112, the power supply 130, the short-range transceiver 120 and antenna 122, and the wireless repeater control module 140. The volume control unit 232 also includes a volume control knob 236 that allows the user to selectively control the volume of an audio signal streamed to the volume control unit (e.g., via Bluetooth®, AirPlay®, etc.) from one or more wireless consumer devices 238A and 238B located near the volume control unit. In this embodiment, the volume control unit 232 also includes a wired audio input jack 240 (e.g., a 3.5 mm jack) configured to receive a plug of an audio cable 242 connected to a media player 244, which facilitates wired communication between the media player and the volume control unit.

The power supply 130 of the volume control unit 232 is coupled to a junction box 246 of the venue 234 via an electrical cable 248, as described above. The volume control unit 232 is configured to receive and transmit wireless signals using one or more communication protocols (e.g., Bluetooth®, AirPlay®, Wi-Fi®, and the like). In this embodiment, the volume control unit 232 is coupled to four speakers 250A-250D located in room 1 of the venue 234. In some embodiments, the volume control unit 232 includes an onboard amplifier 126 (see FIG. 2) configured to drive the four speakers 250A-250D. In these embodiments, the volume control unit 232 may be coupled to the four speakers 250A-250D via speaker wires 252A-252D, respectively.

In addition to wired connection with the speakers 250A-250D, the volume control unit 232 may also be operative to communicate wirelessly with a speaker 254, which is located in a room 2 of the venue 234. The speaker 254 includes wireless communication functionality, and is coupled to the electrical system of the venue 234 via an electrical cable 256 that is tied in to a junction box 258. The volume control unit 232 transmits audio signals via wired and wireless communications that are amplified and played back at the speakers 250A-250D and 254.

As with other embodiments discussed above, the volume control unit 232 and the speaker 254 positioned in room 2 of the venue 234 may function as wireless repeaters. As an example, a wireless consumer device 260 located in room 2 may be able to access the Internet 224 via a chain of wireless connections extending between the wireless consumer device 260, the speaker 254 in room 2, the volume control unit 232 in room 1, and the wireless access point 222 in room 1. Thus, the volume control unit 232 functions to extend the wireless coverage of the wireless access point 222.

In some embodiments, one or more fixed wireless audio devices 104 may include all of the components discussed above (see FIG. 2), while other fixed wireless audio devices may include limited functionality. For example, in a surround sound application that includes five speakers in a single room, it may not be necessary or desirable to have five wireless repeaters and five wireless audio receivers all in the same room. In this and similar applications, one of the speakers may be in the form of an intelligent fixed wireless audio device as described above, while the other four speakers may simply be configured to receive audio signals from the intelligent fixed wireless audio device over a wired or wireless interface. The intelligent fixed wireless audio device may also include one or more decoders (e.g., Dolby Pro Logic IIx, DTS-HD, etc.) operative to decode audio signals into a plurality of audio channels. In some embodiments, all of the fixed wireless audio devices may include the same functionality, but one of them may take on a “master” relationship to control the other devices.

The audio streamed from the wireless consumer devices 106 may include music, voice, or any other audio. For example, a user may utilize the system 100 to stream music from a media player application executing on a wireless consumer device 106 to speakers of the fixed wireless audio devices 104 located within a venue. As another example, a user may utilize the system 100 as a “hands free” speaker system for phone calls, wherein the voice of the person with whom the user is speaking is played on one or more fixed wireless audio devices 104 of the system. As yet another example, the audio may include white noise designed to mask sounds or keep conversations confidential, which may be desirable in venues such as libraries or doctors' offices.

The foregoing described embodiments depict different components contained within, or connected with, different other components. It is to be understood that such depicted architectures are merely exemplary, and that in fact many other architectures can be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermediary components. Likewise, any two components so associated can also be viewed as being “operably connected”, or “operably coupled”, to each other to achieve the desired functionality.

While particular embodiments of the present invention have been shown and described, it will be obvious to those skilled in the art that, based upon the teachings herein, changes and modifications may be made without departing from this invention and its broader aspects and, therefore, the appended claims are to encompass within their scope all such changes and modifications as are within the true spirit and scope of this invention. Furthermore, it is to be understood that the invention is solely defined by the appended claims. It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to inventions containing only one such recitation, even when the same claim includes the introductory phrases “one or more” or “at least one” and indefinite articles such as “a” or “an” (e.g., “a” and/or “an” should typically be interpreted to mean “at least one” or “one or more”); the same holds true for the use of definite articles used to introduce claim recitations. In addition, even if a specific number of an introduced claim recitation is explicitly recited, those skilled in the art will recognize that such recitation should typically be interpreted to mean at least the recited number (e.g., the bare recitation of “two recitations,” without other modifiers, typically means at least two recitations, or two or more recitations).

Accordingly, the invention is not limited except as by the appended claims.

The invention claimed is:

1. A fixed wireless audio device mountable in or to a wall, floor, or a ceiling of a venue for use with a wireless consumer device, comprising:
a memory configured for storing instructions therein;
a processor coupled to the memory and configured for executing the instructions stored in the memory;
a speaker;
an amplifier coupled to the processor and the speaker, the amplifier being operative to drive the speaker;
an antenna;
a short-range transceiver coupled to the antenna and the processor; and
a power supply configured for direct electrical coupling with an electrical source to provide DC power to the other components of the fixed wireless audio device;
wherein the processor executes the instructions to:
cause the short-range transceiver to receive wireless audio signals of a first wireless transmission protocol from the wireless consumer device;
decode the wireless audio signals;
control the amplifier to drive the speaker according to the decoded audio signals; and
cause the short-range transceiver to receive wireless data signals of a second wireless transmission protocol, and to retransmit the wireless data signals.

2. The fixed wireless audio device of claim 1, further comprising a visual output device operatively coupled to the processor, wherein the processor executes the instructions to selectively control the visual output device.

3. The fixed wireless audio device of claim 1, wherein the first wireless transmission protocol is Bluetooth® and the second wireless transmission protocol is IEEE 802.11.

4. The fixed wireless audio device of claim 1, wherein the processor executes the instructions to:
cause the short-range transceiver to receive wireless audio signals of a third wireless transmission protocol from the wireless consumer device;
decode the wireless audio signals; and
control the amplifier to drive the speaker according to the decoded audio signals.

5. The fixed wireless audio device of claim 1, wherein the power supply is further configured for coupling to an electrical cable carrying power over Ethernet (POE).

6. The fixed wireless audio device of claim 1, wherein the processor executes the instructions to receive control signals via at least one of the first and second wireless communication protocols, and to operate the fixed wireless audio device according to the received control signals.

7. The fixed wireless audio device of claim 6 for use with a remote server and a wireless access point, wherein the control signals are received from the remote server accessible by the fixed wireless audio device through the wireless access point communicatively coupled to the remote server that transmits the control signals via the second wireless communication protocol.

8. The fixed wireless audio device of claim 6, wherein the control signals are received from the wireless consumer device via the first communication protocol.

9. An audio system, comprising:
a fixed wireless audio device and a wireless consumer device, the fixed wireless audio device comprising:
a memory configured for storing instructions therein;
a processor coupled to the memory and configured for executing the instructions stored in the memory;
a speaker;
an amplifier coupled to the processor and the speaker, the amplifier being operative to drive the speaker;
an antenna;
a short-range transceiver coupled to the antenna and the processor; and
a power supply configured for direct electrical coupling with an electrical cable associated with an electrical system of the venue, the power supply being operative to provide DC power to the other components of the fixed wireless audio device;
wherein the processor executes the instructions to:
cause the short-range transceiver to receive wireless audio signals of a first wireless transmission protocol from the wireless consumer device;
decode the wireless audio signals;
control the amplifier to drive the speaker according to the decoded audio signals; and
cause the short-range transceiver to receive wireless data signals of a second wireless transmission protocol, and to retransmit the wireless data signals; and
the wireless consumer device comprising:
a memory configured for storing instructions therein;
a processor coupled to the memory and configured for executing the instructions stored in the memory;
an antenna; and
a short-range transceiver coupled to the antenna and the processor;
wherein the processor executes the instructions to:
send the wireless audio signals of the first wireless transmission protocol to the fixed wireless audio device; and
send control signals to the fixed wireless audio device to selectively modify the operation thereof.

10. The system of claim 9 for use with a plurality of wireless consumer devices, wherein the control signals comprise instructions concerning from which one of the plurality of wireless consumer devices the fixed wireless audio device should receive wireless audio signals when the plurality of wireless consumer devices send wireless audio signals simultaneously.

11. A system for distributing audio for use with a wireless consumer device, comprising:
a plurality of fixed wireless audio devices each mountable in or to a wall, floor, or ceiling at different locations within a venue, each of the fixed wireless audio devices comprising:
a memory configured for storing instructions therein;
a processor coupled to the memory and configured for executing the instructions stored in the memory;
a speaker;
an amplifier coupled to the processor and the speaker, the amplifier being operative to drive the speaker;
an antenna;
a short-range transceiver coupled to the antenna and the processor; and
a power supply configured for direct electrical coupling with an electrical cable associated with an electrical system of the venue, the power supply being operative to provide DC power to the other components of the fixed wireless audio device;
wherein the processor executes the instructions to:
cause the short-range transceiver to receive wireless audio signals of a first wireless transmission protocol from the wireless consumer device;
decode the wireless audio signals;
control the amplifier to drive the speaker according to the decoded audio signals; and
cause the short-range transceiver to receive wireless data signals of a second wireless transmission protocol, and to retransmit the wireless data signals.

12. The system of claim 11, wherein each of the processors of the plurality of fixed wireless audio devices is operative to execute the instructions stored on respective memories to transmit and receive audio signals among the plurality of fixed wireless audio devices.

13. The system of claim 11, further comprising control logic operative to selectively control the operation of the plurality of fixed wireless audio devices.

14. The system of claim 13 for use with the wireless consumer device having memory within which the control logic is stored, wherein each of the plurality of fixed wireless audio devices are configured to receive control instructions wirelessly from the wireless consumer device.

15. The system of claim 13 for use with a remote server and a wireless access point, wherein the control logic is stored in a memory of the remote server and each of the plurality of fixed wireless audio devices is configured to receive control instructions from the remote server via the wireless access point communicatively coupled to the remote server.

16. The system of claim 13, wherein the control logic is stored in the respective memories of one or more of the plurality of fixed wireless audio devices.

17. The system of claim 13, wherein the control logic is operative to selectively activate each of the plurality of fixed wireless audio devices.

18. The system of claim 13 for use with a plurality of wireless consumer devices, wherein the control logic is operative to control the plurality of fixed wireless audio devices to select from which one of the plurality of wireless consumer devices the plurality of fixed wireless audio devices should receive wireless audio signals when the plurality of wireless consumer devices send wireless audio signals simultaneously.

19. The system of claim 11 for use with the wireless consumer device comprising a mobile application executing on the wireless consumer device, the mobile application being configured to utilize the wireless consumer device to send control signals to the plurality of fixed wireless audio devices, wherein the plurality of fixed wireless audio devices are configured to operate according to the control signals received from the wireless consumer device.

20. A computer-implemented method for distributing audio within a venue, the method comprising:
receiving wireless audio signals of a first wireless transmission protocol from a wireless consumer device by a fixed wireless audio device comprising a short-range transceiver coupled to an antenna;
decoding the wireless audio signals into decoded audio signals;
outputting the decoded audio signals to a speaker of the fixed wireless audio device;
receiving wireless data signals of a second wireless transmission protocol by the short-range receiver and the antenna of the fixed wireless audio device; and
retransmitting the wireless data signals via the short-range transceiver and the antenna of the fixed wireless audio device.

21. The computer-implemented method of claim 20, further comprising receiving wireless audio signals of the first wireless transmission protocol from a plurality of wireless consumer devices simultaneously, and selecting from which one of the plurality of wireless consumer devices to receive wireless audio signals.

22. The computer-implemented method of claim 20, further comprising selectively controlling a visual output device of the fixed wireless audio device.

23. The computer-implemented method of claim 20, wherein the first wireless transmission protocol is one of Bluetooth® and AirPlay® and the second wireless transmission protocol is IEEE 802.11.

24. The computer-implemented method of claim 20, further comprising:
receiving wireless audio signals of a third wireless transmission protocol from a wireless consumer device by the short-range transceiver coupled to the antenna of the fixed wireless audio device;
decoding the wireless audio signals into decoded audio signals; and
outputting the decoded audio signals to the speaker of the fixed wireless audio device.

25. The computer-implemented method of claim 20, further comprising receiving control signals of one of the first and second wireless communication protocols, and operating the fixed wireless audio device according to the received control signals.

26. The computer-implemented method of claim 25, wherein receiving the control signals comprises receiving signals emanating from a remote server accessible to the fixed wireless audio device by receiving wireless signals from a wireless access point communicatively coupled to the remote server.

27. The computer-implemented method of claim 25, wherein receiving the control signals comprises receiving signals from a wireless consumer device.

28. The computer-implemented method of claim 20, further comprising
sending wireless audio signals of the first transmission protocol from the wireless consumer device to the fixed wireless audio device.

29. The computer-implemented method of claim 20, further comprising sending control signals from the wireless consumer device to the fixed wireless audio device to selectively modify the operation thereof.

30. A method of using a fixed wireless audio device that is mountable in or to a wall, floor, or a ceiling of a venue, the fixed wireless audio device comprising a memory configured for storing instructions therein; a processor coupled to the memory and configured for executing the instructions stored in the memory; a speaker coupled to the processor; an antenna; a short-range transceiver coupled to the antenna and the processor; and a power supply configured for direct electrical coupling with an electrical source to provide DC power to the other components of the fixed wireless audio device; wherein the processor executes the instructions to: cause the short-range transceiver to receive wireless audio signals of a first wireless transmission protocol; decode the wireless audio signals; drive the speaker according to the decoded audio signals; and cause the short-range transceiver to receive wireless data signals of a second wireless transmission protocol, and to retransmit the wireless data signals of the second wireless transmission protocol, the method comprising:
sending wireless audio signals of the first wireless transmission protocol to the fixed wireless audio device for real-time playback of audio through the speaker of the fixed wireless audio device; and
receiving wireless data signals of the second wireless transmission protocol from the fixed wireless audio device, wherein the received wireless data signals comprises wireless data signals retransmitted by the fixed wireless audio device.

31. The method of claim 30, wherein sending wireless audio signals of the first wireless transmission protocol and receiving wireless data signals of the second wireless transmission protocol is performed by a single wireless consumer device.

32. The method of claim 30, wherein the processor executes the instructions to cause the short-range transceiver to receive wireless audio signals of a third wireless transmission protocol, decode the wireless audio signals of the third wireless transmission protocol, and drive the speaker according to the decoded audio signals, the method further comprising:
sending wireless audio signals of the third wireless transmission protocol to the fixed wireless audio device for real-time playback of audio through the speaker of the fixed wireless audio device.

33. The method of claim 30, wherein the first wireless transmission protocol is one of Bluetooth® and AirPlay® and the second wireless transmission protocol is IEEE 802.11.

34. The method of claim 30, further comprising sending wireless control signals to the fixed wireless audio device to selectively modify the operation thereof.

35. The method of claim 30, further comprising communicating with a wireless access point indirectly through the fixed wireless audio device by:
receiving wireless data signals by a wireless consumer device from the wireless access point, wherein the received wireless data signals are first received by the fixed wireless audio device and retransmitted thereby to the wireless consumer device; and
sending wireless data signals by the wireless consumer device to the wireless access point, wherein the sent wireless data signals are first received by the fixed wireless audio device and retransmitted thereby to the wireless access point.

36. The method of claim 30, further comprising sending wireless control signals to a plurality of fixed wireless audio devices to selectively modify the operation thereof.
